(19) United States
(12) Patent Application Publication
(10) Pub. No.: US 2014/0263212 A1
(43) Pub. Date: Sep. 18, 2014

(54) COORDINATION OF BEAM ANGLE AND WORKPIECE MOVEMENT FOR TAPER CONTROL

(71) Applicant: ELECTRO SCIENTIFIC INDUSTRIES, INC., Portland, OR (US)

(72) Inventor: Haibin Zhang, Portland, OR (US)

(73) Assignee: ELECTRO SCIENTIFIC INDUSTRIES, INC., Portland, OR (US)

(21) Appl. No.: 14/205,200

(22) Filed: Mar. 11, 2014

Related U.S. Application Data
(60) Provisional application No. 61/793,589, filed on Mar. 15, 2013.

(51) Int. Cl. B23K 26/08; B23K 26/00; B23K 26/36

(52) U.S. Cl. CPC B23K 26/0876; B23K 26/367; B23K 26/00
USPC 219/121.69; 219/121.68

(57) ABSTRACT

The angle of incidence (ω) and azimuth (φ) of a beam axis (32) can be moved relative to a workpiece (22) to provide desirable taper characteristics to a side wall (124) of a resulting kerf (120) produced by a focused laser beam (30) propagated along the beam axis (32).

### RELATED APPLICATION

This application is a non-provisional application of U.S. Provisional Application No. 61/793,589, which was filed on Mar. 15, 2013, the contents of which are herein incorporated by reference in their entirety for all purposes.

### COPYRIGHT NOTICE

©2014 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This application relates to laser systems and methods for machining features in a workpiece and, in particular, to laser systems and methods for beam coordination to control taper of the cuts made in the workpiece.

### BACKGROUND

Laser machining of workpieces often produce edges along the cut features that exhibit taper, which can be detrimental to the cut quality. FIG. 1 shows a cut or kerf 20 made in a workpiece 22 by conventional laser processing equipment. The laser processing equipment focuses a collimated beam 24 of laser pulses to have a spot size 18 (FIG. 8C) at a focal point 26 that is smaller in size than the beam waist 28 of the collimated beam 24. (The beam waist 28 decreases in size as the collimated beam becomes focused to the focal point 26.) The resulting focused beam 30 is propagated along a beam axis 32 that is perpendicular to a top surface 34 of the workpiece 22. One or more of the beam axis 32 and workpiece 22 are moved relative to each other to provide the focused beam with a cutting direction along the workpiece 22 that determines the path of the kerf 20.

The kerf 20 formed by cutting can be defined by a bottom surface 40 and side walls 42. Taper can be defined with respect to a depthwise axis 44 that is perpendicular to the top surface 34 of the workpiece 22. If a side wall 42 is perpendicular to the top surface 34 of the workpiece 22, then the side wall 42 is parallel to (and collinear with) the depthwise axis 44, and the side wall 42 has a taper of zero.

If, however, the side wall 42 has a slope from the top surface 34 to the bottom surface 40 that leans inward to the center of the kerf 20, then the sidewall made by the cut has a positive taper. The taper may be defined by a taper angle θ that is measured between the side wall 42 and the depthwise axis 44, as shown in FIG. 1. If the side wall 42 has a slope from the top surface 34 to the bottom surface 40 that tilts away from the center of the kerf 20, then the side wall 42 made by the cut has a negative taper.

The taper angle θ can range from a few degrees to more than 10 degrees, or intentionally greater, and may be influenced, but not necessarily controlled by, some laser processing parameters. A large taper is not an ideal result for many cutting applications. Moreover, minimized taper or a taper of approximately zero is a desirable result for many cutting applications.

### SUMMARY

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

In some embodiments, a method of laser-machining a feature in a workpiece comprises: providing a workpiece; producing a beam of laser light; directing the beam onto the workpiece to irradiate a region of the workpiece with the beam, wherein the beam is incident upon the workpiece at an angle of incidence and is incident upon the workpiece along an azimuthal direction relative to the workpiece; removing a portion of the workpiece within the irradiated region; causing movement of the irradiated region relative to the workpiece along a machining path within the workpiece; and changing the azimuthal direction of the beam relative to the workpiece based on a position of the irradiated region along the machining path.

In some alternative, additional, or cumulative embodiments, the beam includes at least one pulse of laser light.

In some alternative, additional, or cumulative embodiments, laser light within the beam has at least one wavelength greater than 100 nm.

In some alternative, additional, or cumulative embodiments, laser light within the beam has at least one wavelength less than 11 μm.

In some alternative, additional, or cumulative embodiments, causing movement of the irradiated region relative to the workpiece comprises moving the workpiece relative to the beam.

In some alternative, additional, or cumulative embodiments, moving the workpiece relative to the beam comprises linearly translating the workpiece.

In some alternative, additional, or cumulative embodiments, moving the workpiece relative to the beam comprises rotationally translating the workpiece.

In some alternative, additional, or cumulative embodiments, at least a portion of the machining path is straight.

In some alternative, additional, or cumulative embodiments, at least a portion of the machining path is curved.

In some alternative, additional, or cumulative embodiments, the beam is focused.

In some alternative, additional, or cumulative embodiments, changing the azimuthal direction of the beam relative to the workpiece comprises deflecting the beam.

In some alternative, additional, or cumulative embodiments, deflecting the beam comprises reflecting the beam.

In some alternative, additional, or cumulative embodiments, deflecting the beam comprises refracting the beam.

In some alternative, additional, or cumulative embodiments, the beam is deflected before focusing the beam.

In some alternative, additional, or cumulative embodiments, the beam is deflected after focusing the beam.

In some alternative, additional, or cumulative embodiments, the beam is deflected the beam and focused simultaneously.

In some alternative, additional, or cumulative embodiments, the angle of incidence is changed based on a position of the irradiated region along the machining path.

In some alternative, additional, or cumulative embodiments, a method of laser-machining a feature in a workpiece comprises: providing a workpiece; generating a beam of laser light; focusing the beam onto the workpiece to irradiate a region of the workpiece, wherein the beam is incident upon the workpiece at an angle of incidence and is incident upon the workpiece along an azimuthal direction relative to the workpiece; moving causing movement of the irradiated region relative to the workpiece along a machining path within the workpiece; and changing the azimuthal direction of the beam relative to the workpiece based on a position of the irradiated region along the machining path.

In some alternative, additional, or cumulative embodiments, a method for laser-machining a feature in a workpiece, comprises: providing a workpiece; generating a beam of laser pulses along a beam axis; causing relative motion between the beam axis and the workpiece in a cutting direction along a cutting path; directing the beam axis onto the workpiece to irradiate a first region on the workpiece along the cutting path with the beam, wherein the beam axis is incident upon the workpiece at a first nonzero machining angle and impinges upon the workpiece along a first nonzero azimuthal direction relative to the cutting path; removing material of the workpiece within the first region along the cutting path to form a kerf including a first side wall having a first taper characteristic influenced by the first angle of incidence and the first azimuthal direction; changing the first azimuthal direction of the beam axis relative to the cutting path; directing the beam axis onto the workpiece to irradiate a second region on the workpiece along the cutting path with the beam, wherein the beam axis is incident upon the workpiece at a second nonzero machining angle and impinges upon the workpiece along a second nonzero azimuthal direction relative to the cutting path, wherein the second nonzero azimuthal direction is different from the first nonzero azimuthal direction; and removing material of the workpiece within the second region along the cutting path to form a second side wall having a second taper characteristic influenced by the second angle of incidence and the second azimuthal direction.

In some embodiments, the machining angle of the beam axis is the angle of incidence with respect to the workpiece.

In some embodiments, the angle of incidence is substantially equal to the beam-axis angle.

In some alternative, additional, or cumulative embodiments, a method for laser-machining a feature in a workpiece comprises: providing a workpiece; generating a beam of laser pulses along a beam axis propagating through a non-telecentric lens having a utilizable field of view over the workpiece, wherein the field of view has a perimeter; causing relative motion between the beam axis and the workpiece in a cutting direction along a cutting path; directing the beam axis through the non-telecentric lens onto the workpiece in proximity to the perimeter of the field of view to irradiate a first region on the workpiece along a cutting path with the beam, wherein the beam axis is incident upon the workpiece at a first nonzero machining angle and impinges upon the workpiece along a first nonzero azimuthal direction relative to the workpiece; and removing material of the workpiece within the first region along the cutting path to form a kerf including a first side wall having a first taper characteristic influenced by the first angle of incidence and the first azimuthal direction.

In some alternative, additional, or cumulative embodiments, the beam axis continues to be directed through the non-telecentric lens onto the workpiece in proximity to the perimeter of the field of view to maintain the first taper characteristic of the first side wall while the kerf is extended along the cutting path.

In some alternative, additional, or cumulative embodiments, the cutting path has curvature, and the first azimuthal direction of the beam axis is changed relative to the workpiece to adjust for the curvature of the cutting path.

In some alternative, additional, or cumulative embodiments, the cutting path has curvature, the first region forms a first segment along the cutting path in a first direction, and the first azimuthal direction of the beam axis is changed relative to the workpiece to cause direction of the beam axis through the non-telecentric lens onto the workpiece in proximity to the perimeter of the field of view to irradiate a second region on the workpiece along the cutting path with the beam, wherein the beam axis is incident upon the workpiece at a second nonzero machining angle and impinges upon the workpiece along a second nonzero azimuthal direction relative to the workpiece, wherein the second nonzero azimuthal direction is different from the first nonzero azimuthal direction, and wherein the second region forms a second segment along the cutting path in a second direction that departs from the first direction, and wherein the material of the workpiece is removed within the second region along the cutting path to extend the kerf in the second direction while maintaining the first taper characteristic of the first side wall as influenced by the second angle of incidence and the second azimuthal direction.

In some alternative, additional, or cumulative embodiments, the first machining angle of the beam axis is oriented at a nonzero beam-axis angle with respect to a lens axis of a non-telecentric lens.

In some alternative, additional, or cumulative embodiments, the first machining angle of the beam axis is oriented at a nonzero and non-perpendicular beam-axis angle with respect to an axial plane of a non-telecentric lens.

In some alternative, additional, or cumulative embodiments, the beam axis is directed to impinge the workpiece within 5 mm of the perimeter of the utilizable field of view.

In some alternative, additional, or cumulative embodiments, the beam axis is directed to impinge the workpiece within 1 mm of the perimeter of the utilizable field of view.

In some alternative, additional, or cumulative embodiments, the beam axis is directed to impinge the workpiece within 100 microns of the perimeter of the utilizable field of view.

In some alternative, additional, or cumulative embodiments, the first machining angle of the beam axis is greater than 2 degrees.

In some alternative, additional, or cumulative embodiments, the first machining angle of the beam axis is greater than 5 degrees.

In some alternative, additional, or cumulative embodiments, the first machining angle of the beam axis is greater than 2 degrees and smaller than 10 degrees.

In some alternative, additional, or cumulative embodiments, the first machining angle of the beam axis is smaller than 20 degrees.

In some alternative, additional, or cumulative embodiments, the first machining angle and the second machining angle are the same.

In some alternative, additional, or cumulative embodiments, the first machining angle and the second machining angle are different.

In some alternative, additional, or cumulative embodiments, the first azimuthal direction has an angular value that is greater than or equal to 20 degrees and less than 180 degrees.

In some alternative, additional, or cumulative embodiments, the first azimuthal direction has an angular value that is about 90 degrees.

In some alternative, additional, or cumulative embodiments, the first azimuthal direction and the second azimuthal direction have angular values that are the same in the different directions.

In some alternative, additional, or cumulative embodiments, the first azimuthal direction and the second azimuthal direction have angular values that are different in the different directions.

In some alternative, additional, or cumulative embodiments, the first side wall and the second side wall have the same taper.

In some alternative, additional, or cumulative embodiments, the first side wall and the second side wall have the same characteristics.

In some alternative, additional, or cumulative embodiments, the first side wall and the second side wall have intentionally different taper.

In some alternative, additional, or cumulative embodiments, the beam axis is directed in a beam path on the workpiece in a repetitive pattern smaller than a width of the kerf and such that some laser spots along the beam path are first laser spots that form the first side wall and such that some laser spots along the beam path are second laser spots that form a second side wall, wherein the first laser spots are directed in the first azimuthal direction and wherein the second laser spots are directed in a second azimuthal direction.

In some alternative, additional, or cumulative embodiments, a method for laser-machining a feature in a workpiece, comprises: providing a workpiece; generating a beam of laser pulses along a beam axis; causing relative motion between the beam axis and the workpiece in a cutting direction along a cutting path; directing the beam axis onto the workpiece to irradiate a first region on the workpiece along the cutting path with the beam, wherein the beam axis is incident upon the workpiece at a first nonzero machining angle and impinges upon the workpiece along a first nonzero azimuthal direction relative to the cutting path; removing material of the workpiece within the first region along the cutting path to form a kerf including a first side wall having a first taper characteristic influenced by the first angle of incidence and the first azimuthal direction; changing the first azimuthal direction of the beam axis relative to the cutting path; directing the beam axis onto the workpiece to irradiate a second region on the workpiece along the cutting path with the beam, wherein the beam axis is incident upon the workpiece at a second nonzero machining angle and impinges upon the workpiece along a second nonzero azimuthal direction relative to the cutting path, wherein the second nonzero azimuthal direction is different from the first nonzero azimuthal direction; and removing material of the workpiece within the second region along the cutting path to form a second side wall having a second taper characteristic influenced by the second angle of incidence and the second azimuthal direction.

In some alternative, additional, or cumulative embodiments, a laser micromachining system for laser-machining a feature in a workpiece, comprises: a laser operable for generating a beam of laser pulses of selected pulse parameters along a beam axis; a non-telecentric lens operable for propagating therethrough and having a utilizable field of view over the workpiece, wherein the field of view has a perimeter; a workpiece stage operable for supporting and moving the workpiece; a fast positioner operable for directing the beam axis through the non-telecentric lens and directly or indirectly toward target positions on the workpiece; a positioner stage for supporting and moving a fast positioner relative to the workpiece; and a controller operable to control motion of the workpiece stage and the fast positioner stage and operable to control the fast positioner to direct the laser pulses along the beam axis and maintain the beam axis at one or more selected machining angles and one or more selected azimuths through the non-telecentric lens onto the workpiece in proximity to the perimeter of the field of view to the target positions to form a kerf having a side wall with selected taper characteristics determined by the selected pulse parameters, the one or more selected machining angles, and the one or more selected azimuths.

In some alternative, additional, or cumulative embodiments, a method for laser-machining a feature in a workpiece, comprises: providing a workpiece having a surface; providing a workpiece stage operable for supporting the workpiece and moving the workpiece; generating a beam of laser pulses having selected laser parameters and propagating the laser pulses along a beam axis; providing a fast positioner operable for directing the beam axis through the non-telecentric lens and directly or indirectly toward target positions on the workpiece, wherein the non-telecentric lens has a central lens axis that is generally perpendicular to the surface of the workpiece; causing relative motion between the beam axis and the workpiece in a cutting direction along a cutting path; and directing the beam axis through the non-telecentric lens onto the workpiece to irradiate a first region on the workpiece along a cutting path with the beam to remove material of the workpiece within the first region along the cutting path to form a kerf including a first side wall, a bottom, and a second side wall, wherein the central lens axis is positioned at a greater distance from the first side wall than from the second side wall, the wherein the beam axis is incident upon the workpiece at a selected nonzero machining angle and impinges upon the workpiece along a selected nonzero azimuthal direction relative to the cutting direction such that the first side wall is formed with a taper characteristic determined by the selected pulse parameters, the selected machining angle, and the selected azimuthal direction.

Additional aspects and advantages will be apparent from the following detailed description of preferred embodiments, which proceeds with reference to the accompanying drawings.

### BRIEF DESCRIPTION OF THE DRAWINGS

FIG. 1 is a side elevation cross-sectional view of a cut or kerf made in a workpiece by conventional laser processing equipment.

FIG. 2 is a side elevation cross-sectional view of an exemplary cut or kerf made with a beam axis that is collinear with a lens axis of a lens.

FIG. 3 is a side elevation cross-sectional view of an exemplary cut or kerf made with the beam axis oriented at a nonperpendicular angle with respect to the surface of the workpiece and at a first azimuthal direction with respect to a cutting path along the surface of the workpiece.

FIG. 4 is a side elevation cross-sectional view of an exemplary cut or kerf made with the beam axis oriented at a nonperpendicular angle with respect to the surface of the workpiece and at a second azimuthal direction with respect to a cutting path along the surface of the workpiece.

FIG. 5 is top plan view depicting exemplary relative coordinated movement between the beam axis and the workpiece to form a circular feature with desirable taper characteristics in an outer kerf wall by directing the beam axis to impinge the workpiece in proximity to the perimeter of a utilizable field of view.

FIG. 6 is top plan view depicting exemplary relative coordinated movement between the beam axis and the workpiece to form a circular feature with desirable taper characteristics in an inner kerf wall by directing the beam axis to impinge the workpiece in proximity to the perimeter of a utilizable field of view.

FIG. 7 is top plan view of cutting paths that circumscribe an elliptical feature.

FIG. 8A is a top plan view of an exemplary beam path on a workpiece to form a kerf along a cutting path.

FIG. 8B is an enlarged top plan view of an exemplary beam path on a workpiece to form the kerf along the cutting path shown in FIG. 8A.

FIG. 8C is a computer model showing a top plan view of individual placement of laser spots at the work surface along the beam path resulting from continuous movement of the beam axis by the positioner.

FIG. 9 is a schematic diagram of a laser micromachining system operable for making kerfs having controlled taper.

FIG. 10 is a top plan view of representative working envelopes of various positioning elements.

### DETAILED DESCRIPTION OF EXEMPLARY EMBODIMENTS

Example embodiments are described below with reference to the accompanying drawings. Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of components may be exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

The following embodiments are presented only herein by way of example to cutting kerfs 20 in a workpiece 22. Such embodiments are representative of any feature-cutting operation and, particularly, trepanning operations. Taper control in such laser material processing operations can be a challenge because of at least two major reasons: 1) the laser beam 24 exhibits divergence, such that the workpiece 22 experiences different beam waist 28 and peak intensity as the depth 50 of cut in the workpiece 22 increases; and 2) the power reaching the bottom surface 40 of the cut decreases as a function of depth due to scattering and refraction effects.

FIG. 2 is a cross-sectional view of an exemplary cut or kerf 20a made with a beam axis 32 that is collinear with a lens axis 60 of a non-telecentric scanning or focusing lens 62 (and perpendicular to an axial plane 64 of the scanning or focusing lens 62). As later described with respect to FIG. 9, the laser beam 24 is propagated along an optical path 80 and ultimately directed along the beam axis 32 by a fast positioner 90 that has a field of view (FOV) 100 (FIG. 5) through the lens 62 that is defined by limits in the angular range of deflection of the beam axis 32 associated with the constraints of the fast positioner 90 and the lens 62. The fast positioner 90 is mounted to a stage 92 of a beam positioning system 94, and the position of the stage 92 with respect to the workpiece defines an area on the workpiece of instantaneous positions available to the laser spot 102 (FIG. 8C) within the FOV 100. With respect to the process depicted in FIG. 2, the beam axis 32 is directed at the center (as represented by the circle 98) of the field of view 100, and the kerf 20a may have similar characteristics to the kerf 20, such as exhibiting significant positive taper on both of the side walls 42.

FIG. 3 is a cross-sectional view of an exemplary cut or kerf 120a made with the beam axis 32 oriented at a first nonperpendicular impingement angle α with respect to the surface 34 and at a first azimuthal direction with respect to a cutting path 122 or cutting direction 128 (FIG. 8A) along the surface 34 of the workpiece 22. The azimuthal direction is transverse to the direction of the cutting path 122 on the workpiece 22 and can generally be defined as a horizontal angle or azimuth φ measured from the direction of the cutting path 122, or as a horizontal angle or azimuth φ measured from an axis 148 that bisects the workpiece, or as a horizontal angle or azimuth φ measured from an axis that bisects a feature to be cut. Similarly, FIG. 4 is a cross-sectional view of an exemplary cut or kerf 120a made with the beam axis 32 oriented at a second nonperpendicular impingement angle α with respect to the surface 34 and at a second azimuthal direction φ with respect to the cutting direction 128 of cutting path 122 along the surface 34 of the workpiece 22, or as a horizontal angle or azimuth φ measured from the axis 148 that bisects the workpiece, or as a horizontal angle or azimuth φ measured from the axis that bisects a feature to be cut.

With reference to FIGS. 3 and 4, the side walls 42 of kerfs 120a and 120b (generally kerfs 120) can be individually referred to as left side wall 124ₐ and right side wall 124_{b} with respect to the cutting direction 128 (the viewing direction into the page containing FIGS. 3 and 4) of cutting 128 path 122. Moreover, the left side wall 124ₐ can be defined as the side wall 124 immediately counterclockwise to the cutting direction 128 of cutting path 122, and the right side wall 124_{b} can be defined as the side wall 124 immediately clockwise to the cutting direction 128 of cutting path 122. The side walls 124 can also be discussed as inner and outer side walls 124 with respect to whether they are proximal or distal to the center of feature being machined.

In some embodiments, the beam axis 32 may be directed at a nonzero beam-axis angle ω with respect to the lens axis 60 of the lens 62 (and at a nonzero and non-perpendicular angle φ to the axial plane 64 of the lens 62) and in the azimuthal direction φ that is direction traverse to the cutting path 122. In some embodiments, the beam-axis angle ω is the angle of incidence of the beam axis 32 with respect to the surface 34. In some embodiments, the beam axis 32 may be directed at complimentary angle γ with respect to the depthwise axis 44.

With reference to FIGS. 3 and 4, with a non-telecentric lens 62, the focused beam 30 cuts the material of the workpiece 22 with different tapers according to the relative positions between the beam axis 32 and the workpiece 22. For example, with reference to FIG. 3, whenever the workpiece 22 is on the left with respect to lens' field of view 100 so that the beam axis 32 has an angle tilting left (left tilting beam-axis angle ω or angle Φ, or right tilting impingement angle α or complimentary angle γ, the left side wall 124a of the resulting kerf 120 will exhibit less taper than that of the right side wall 124b due to the machining angle and the azimuthal direction Φ of the beam axis 32. With proper coordination between the machining angle and the azimuthal direction Φ of the beam axis 32 and other laser parameters, the laser machining system 88 can achieve desirable taper characteristics including but not limited to low values of positive taper, zero taper, or negative taper.

In some embodiments, desirable taper characteristics may include a taper angle θ that is measured between the side wall 124 and the depthwise axis 44, that is less than or equal to 5 degrees. In some embodiments, the taper angle θ is less than or equal to 1 degree. In some embodiments, the taper angle θ is less than or equal to 0.5 degree. In some embodiments, the taper angle θ is less than or equal to 0.1 degree. In some embodiments, desirable taper characteristics may include other qualities of the side wall 124, such as texture or smoothness, or the homogeneity of the texture or smoothness.

With reference to FIG. 4, whenever the workpiece 22 is on the right with respect to lens' field of view 100 so that the beam axis 32 has an angle tilting right (right tilting beam-axis angle ω or angle Φ, or left tilting impingement angle α or complimentary angle γ), the right side wall 124b of the resulting kerf 120 will exhibit less taper than that of the left side wall 124a due to the machining angle and the azimuthal direction Φ of the beam axis 32.

With continued reference to FIGS. 3 and 4, in some embodiments, the machining angle of the beam axis 32 is greater than or equal to 1 degree and less than 20 degrees. In some embodiments, the machining angle of the beam axis 32 is greater than or equal to 1 degree and less than 10 degrees. In some embodiments, the machining angle of the beam axis 32 is greater than or equal to 2 degrees. In some embodiments, the machining angle of the beam axis 32 is greater than or equal to 5 degrees. In some embodiments, the machining angle of the beam axis 32 is greater than or equal to 8 degrees. In some embodiments, the machining angle of the beam axis 32 is greater than or equal to 1 degree and less than 10 degrees.

In some embodiments, the azimuth Φ of the beam axis 32, such as for cutting a straight kerf 120, is greater than or equal to 20 degrees and less than 180 degrees with respect to the cutting direction 128. In some embodiments, the azimuth Φ of the beam axis 32 is greater than or equal to 45 degrees with respect to the cutting direction 128. In some embodiments, the azimuth Φ of the beam axis 32 is greater than or equal to 45 degrees and less than or equal to 135 degrees with respect to the cutting direction 128. In some embodiments, the azimuth Φ of the beam axis 32 is greater than or equal to 70 degrees and less than or equal to 110 degrees with respect to the cutting direction 128. In some embodiments, the azimuth Φ of the beam axis 32 is about 90 degrees with respect to the cutting direction 128. However, for machining a closed looped cutting path 122 such as for a circle, ellipse, or oval, the azimuth Φ of the beam axis 32 may be 360 degrees with respect to the bisecting axis 148 of the workpiece 22 and may change as the beam axis 32 circumnavigates the perimeter.

In some embodiments, the relative movement includes directing the beam axis 32 through the non-telecentric lens 62 onto the workpiece 22 such that the central axis 60 of the lens 62 is positioned at a greater distance from the first side wall 124a than from the second side wall 124b so that the beam axis 32 is incident upon the workpiece 22 at a selected nonzero machining angle ω and impinges upon the workpiece 22 along a selected nonzero azimuthal direction Φ relative to the cutting direction 128 such that the first side wall 124a is formed with a taper characteristic determined by the selected pulse parameters, the selected machining angle ω, and the selected azimuthal direction Φ.

In some embodiments, the beam axis 32 is directed to impinge the workpiece 22 in proximity to the perimeter of the utilizable field of view 100 of the fast positioner 90 and/or the lens 62 to effect the machining angle. In some embodiments, the beam axis 32 is directed to impinge the workpiece 22 within 5 mm of the perimeter of the utilizable field of view 100. In some embodiments, the beam axis 32 is directed to impinge the workpiece 22 within 2 mm of the perimeter of the utilizable field of view 100. In some embodiments, the beam axis 32 is directed to impinge the workpiece 22 within 2 mm of the perimeter of the utilizable field of view 100. In some embodiments, the beam axis 32 is directed to impinge the workpiece 22 within 500 microns of the perimeter of the utilizable field of view 100. In some embodiments, the beam axis 32 is directed to impinge the workpiece 22 within 100 microns of the perimeter of the utilizable field of view 100. In some embodiments, the beam axis 32 is directed to impinge the workpiece 22 within 25 microns of the perimeter of the utilizable field of view 100.

In some embodiments, the utilizable field of view 100 has a diameter, and the beam axis 32 is directed to impinge the workpiece 22 within 40% of the diameter with respect to the perimeter of the utilizable field of view 100. In some embodiments, the beam axis 32 is directed to impinge the workpiece 22 within 30% of the diameter with respect to the perimeter of the utilizable field of view 100. In some embodiments, the beam axis 32 is directed to impinge the workpiece 22 within 20% of the diameter with respect to the perimeter of the utilizable field of view 100.

In some embodiments, the utilizable field of view 100 has a diameter (or major axis) of 10 mm to 100 mm. In some embodiments, the utilizable field of view 100 has a diameter that is greater than 15 mm. In some embodiments, the utilizable field of view 100 has a diameter of 25 mm to 50 mm. In some embodiments, the utilizable field of view 100 has a diameter that is smaller than 75 mm.

FIG. 5 is top plan view depicting exemplary relative coordinated movement 130a between the beam axis 32 and the workpiece 22 along a circular cutting path 122 to form a circular feature 140 with desirable taper characteristics in the outer kerf wall 124 by directing the beam axis 32 to impinge the workpiece 22 in proximity to the perimeter of a utilizable field of view 100.

With reference to FIG. 5, in some embodiments in which the circular feature 140 is removed from the workpiece 22, such as to form a through-hole via, the taper of the outer side wall 124a is controlled. In some embodiments, the relative movement 130a includes moving the work piece 22 to circle at or in proximity to the perimeter of the field of view 100 of the lens 62 with the feature moving generally inside the field of view 100 (when the field of view 100 is large compare to the size of the feature 140), such that the beam axis 32 is focused on the outer edge of the circular feature 140. In some embodiments, the azimuth Φ of the beam axis 32 rotates about a central axis such as the lens axis 60, and the workpiece 22 revolves around the perimeter of the field of view 100. In some embodiments, the azimuth Φ of the beam axis 32 is stationary, and the workpiece 22 rotates on an axis at the center of the circular feature 140 while the workpiece 22 revolves around the perimeter of the field of view 100. In some embodiment, the azimuth Φ of the beam axis 32 rotates, and the workpiece 22 rotates while the workpiece 22 revolves around the perimeter of the field of view 100. As previously discussed, the taper is selected by controlling the machining angle, the azimuth Φ, and the other laser parameters. The taper of the inner side wall 124b need not be concern in such embodiments.

However, with reference to FIG. 6, in some embodiments, in which the circular feature 140 is removed from the workpiece 22, such as to form a circular disc, the taper of the inner side wall 124b is controlled. FIG. 6 is top plan view depicting exemplary relative coordinated movement 130b between the beam axis 32 and the workpiece 22 along a circular cutting path 122 to form a circular feature 140 with desirable taper characteristics in the inner kerf wall 124 by directing the beam axis 32 to impinge the workpiece 22 in proximity to the perimeter of the utilizable field of view 100.

In some embodiments, the relative movement 130b includes moving the work piece 22 to circle at or in proximity to the perimeter of the field of view 100 of the lens 62 with the feature moving generally outsideside the field of view 100 (when the field of view 100 is large compare to the size of the feature 140), such that the beam axis 32 is focused on the inner edge of the circular feature 140. In some embodiments, the azimuth Φ of the beam axis 32 rotates about a central axis such as the lens axis 60, and the workpiece 22 revolves around the perimeter of the field of view 100. In some embodiments, the azimuth Φ of the beam axis 32 is stationary, and the workpiece 22 rotates on an axis at the center of the circular feature 140 while the workpiece 22 revolves around the perimeter of the field of view 100. In some embodiment, the azimuth Φ of the beam axis 32 rotates, and the workpiece 22 rotates while the workpiece 22 revolves around the perimeter of the field of view 100. As previously discussed, the taper is selected by controlling the machining angle, the azimuth Φ, and the other laser parameters. The taper of the outer side wall 124a need not be concern in such embodiments.

Depending on the shape of cutout feature, such as circular feature 140, one can calculate a relative offset for the workpiece 22 from the center of the filed of view 100 and the angle desired for the beam axis 32 (in cooperation with other laser parameters) to achieve the desired taper for a sidewall 24.

In some embodiments, the workpiece is moved at the speed of laser processing. In some embodiments, the combination of the beam moving speed and the workpiece moving speed provides the overall relative speed between the beam axis 32 and the workpiece 22 for laser processing and may translate into the bite size of the laser machining process. In some embodiments, such relative movement between the beam axis 32 and the workpiece 22 at a desirable laser processing speed (and desirable bite size) may utilize a fast moving speed of the workpiece 22 over an area similar to the size of the field of view 100 of the lens 62 and/or the fast positioner 90.

With reference to FIG. 7, in some embodiments, the relative movements provide a beam path 142 along the cutting path 122 that resembles the path of the kerf 120. FIG. 7 is top plan view of beam paths 142 that circumnavigate an elliptical feature 140a. These beam paths 142 are shown as concentric cutting paths 122 but may additionally or alternatively be substantially identical but separated depthwise if the feature 140a is to be removed. These beam paths 142 can be accomplished by the aforementioned relative movement techniques previously discussed, such as by moving the workpiece 22 and continually changing the azimuth, especially when the feature 140a is relatively small or not much bigger than the filed of view 100.

However, if the feature 140a or the workpiece 22 is large, the bandwidth of a stage 150 for moving and supporting the workpiece 22 may be challenged to provide adequate relative movement of the workpiece 22. Thus, in some embodiments, the beam path 142 on the workpiece 22 can be different from the cutting path 122. FIG. 8A is a top plan view of a portion of an exemplary straight-line cutting path 122 to form a kerf 120. FIG. 8B is an enlarged top plan view of an exemplary beam path 142 on a workpiece 22 to form the kerf 120 along the cutting path 122 shown in FIG. 8A. With reference to FIG. 8B, the kerf 120 can be made to a desired overall kerf width 144 by localized beam path repetitions of circles, ellipse, lateral scan lines, or other beam path patterns to reduce bandwidth demands on the workpiece stage 150. FIG. 8C is a computer model showing a top plan view of individual placement of laser spots 102 at the work surface along the beam path 142 resulting from continuous movement of the beam axis 32 by the fast positioner 90 and/or a high-speed positioner 160.

With reference to FIGS. 8A-8C (collectively FIG. 8), exemplary demonstrative parameters include: a PRF of about 18 kHz; a spot size of about 25 μm; a linear velocity (the rate the small rotating circular pattern is moving across the work surface) of about 50 mm/sec; a rotation rate (the rate the circular pattern is rotating) of about 2 kHz; a rotation aptitude (the diameter of the circular pattern (to center of beam)) of about 30 μm; an inside diameter (the starting diameter of the spiral pattern (to center of circular pattern)) of about 10 μm; an outside diameter (the end diameter of spiral pattern (to center of circular pattern)) of about 150 μm; and a number of cycles (the number of rotations of the spiral pattern) of about 2. The model shows that in order to support laser pulse rates in the 15 to 20 kHz range, a rotation rate of 1 kHz to 2.5 kHz (5 to 15 pulses per rotation) is desired for a practical pulse overlap.

With reference again to FIG. 8, this technique permits a kerf wider than the spot diameter 18 to be formed in fewer passes while maintaining the machining quality and other benefits of using a focused output beam 30 (i.e. without defocusing the beam to achieve a wider spot). In addition, the beam path 142 may be beyond the bandwidth capabilities of the workpiece stage 150 or some fast positioners 90 for high relative movement applications. However, the workpiece stage 150 or the fast positioner stage 92 may be shifted, if necessary, to provide the fast positioner 90 or the high-speed positioner 160 with sufficient distance from the side walls 124a and 124b to accommodate desired non-perpendicular incident machining angle ω and azimuth Φ for the laser spots 102a and 102b to provide the respective side walls 124a and 124b with the desired taper. The laser spots 102 not forming the side walls 124 do not necessarily need to have a non-perpendicular incident machining angle ω and an azimuth Φ. Moreover, the relative movement can be implemented for the fast positioner 90 and/or high-speed positioner 150 to direct the beam axis 32 at or in proximity to the perimeter of the utilizable field of view 100. This technique can be used to machine a cutting path 122 of any curvature, such the edge of a blind via. It will be noted that this technique advances the techniques disclosed in U.S. Pat. No. 6,706,998 of Donald Cutler et al. by intentionally selecting the incident machining angle ω and the azimuth Φ and by intentionally utilizing the perimeter of the utilizable field of view 100. U.S. Pat. No. 6,706,998 of Donald Cutler et al., which is assigned to the assignee of this application, is incorporated herein by reference.

FIG. 9 is a schematic diagram of a laser micromachining system operable for making kerfs having controlled taper. With reference to FIG. 9, laser output 164 may be manipulated by a variety of well-known optics including optional beam expander lens components 166 (and/or optional attenuators or pulse pickers, such as acousto-optic or electro-optic devices, and/or feedback sensors, such as for energy, timing, or position) that are positioned along the optical path 80 before being directed by a series of beam-directing components 170 (such as stage axis positioning mirrors), an optional high-speed positioner 160, and a fast positioner 90 (such as a pair of galvanometer-driven X- and Y-axis mirrors) of the beam positioning system 94. Finally, laser output 164 is passed through the lens 22, such as a non-telecentric focusing lens, scanning lens, or f-theta lens, before being directed as the focused laser output beam 30 along the beam axis 32 to form the laser spot 102 on workpiece 22.

In some embodiments, the beam positioning system 90 employs a translation stage positioner that preferably controls at least two platforms or stages 150 and 92 and supports the positioning components 170 to target and focus the laser output beam 30 to a desired laser target position 180. In a some embodiments, the translation stage positioner is a split-axis system where a Y stage 150, typically moved by linear motors, supports and moves the workpiece 22; an X stage 92 supports and moves the fast positioner 90 and the lens 62; a Z stage 182 can adjust the Z dimension between the X and Y stages; and the beam-directing components 170 align the opitcal path 80 through any turns between a laser 184 and the fast positioner 90. The workpiece stage 150 may be operable to travel along a single axis, such as the Y-axis, or the workpiece stage 150 may be operable to travel along transverse axes, such as the X- and Y-axes. Alternatively or additionally, the workpiece stage 150 may be operable to rotate the workpiece 22, such as about a Z-axis (solely, or as well as move the workpiece along the X- and Y-axes). For example, the workpiece stage 152 may support an additional rotation stage 152 that rotates the workpiece about an axis. A typical translation stage positioner is capable of a velocity of 2 or 3 m/sec and an acceleration of 1.5 G or greater. Current cost effective translation stages perform in a range of about 400 mm/sec to about 1 m/sec. Naturally, they can move much more slowly as well. For convenience, the combination of the fast positioner 90 and one or more translation stages 150 and/or 92 may be referred to as a primary or integrated positioning system.

A typical fast positioner 90 employs a pair of galvanometer-controlled mirrors capable of quickly changing the direction of the beam axis 32 over a relatively large field of view 100 over the workpiece 22. Such field of view 100 is typically smaller than the field of movement provided by the workpiece stage 150. A high-speed positioner 160, such as an acousto-optic device or a deformable mirror (or other fast steering mirror), may alternatively be used as the fast positioner 90, even though these devices tend to have smaller beam deflection ranges than galvanometer mirrors. Alternatively, the high-speed positioner may be employ in addition to the galvanometer mirrors. An exemplary fast positioner is capable of a linear velocity from about 2 or 3 m/sec to about 10 m/sec and an acceleration of about 1000 to 2000 G, and hence these are also the typical capabilities of an exemplary integrated positioning system. Naturally, the linear velocity can operate below these ranges as well.

FIG. 10 is a top plan view of representative working envelopes of various positioning elements. With reference to FIG. 10, the linear stages 152 and 92 provide a stage envelope 172 that is typically larger than a fast positioner envelope 174 of the fast positioner 90. In some embodiments, the fast positioner envelope 174 is smaller than or equal to 500 mm². In some embodiments, the fast positioner envelope 174 may be equivalent to the filed of view 100 of the fast positioner 90. In some embodiments, the fast positioner envelope 174 is smaller than or equal to 300 mm², or smaller than or equal to 100 mm², or smaller than or equal to 25 mm². The fast positioner envelope 174 is typically larger than a high-speed positioner envelope 176 of the high-speed positioner 160. Some or all of the envelopes of these positioning components may be utilized to provide the beam axis 32 with the desired incident machining angle ω and azimuth Φ with respect to the workpiece 22 to achieve the desired taper of a side wall 124.

For example, with reference to FIGS. 3 and 10, the linear stage envelope 172 (workpiece stage 150) and/or the fast positioner envelope 174 (fast positioner stage 92) can be shifted to the left and/or the high-speed positioner envelope 176 can be shifted to the right (by shifting the azimuthal direction to the left and/or increasing the angle of incidence) to accommodate the desired incident machining angle ω and azimuth Φ with respect to the formation of the side wall 124a with the desired taper. Similarly, with reference to FIGS. 4 and 10, the linear stage envelope 172 (workpiece stage 150) and/or the fast positioner envelope 174 (fast positioner stage 92) can be shifted to the right and/or the high-speed positioner envelope 176 can be shifted to the left (by shifting the azimuthal direction to the right and/or increasing the angle of incidence) to accommodate the desired incident machining angle ω and azimuth Φ with respect to the formation of the side wall 124b with the desired taper.

In some embodiments, the lens 62 may have a fixed position with respect to the fast positioner 90 such that the lens axis 60 and the axial plane of the lens 62 are stationary with respect to the fast positioner 90 and or the stage 92. In other embodiments, the lens 62 may be moveable with respect to the fast positioner such that the lens 62 can be moved within the axial plane 64 and/or the axial plane 64 of the lens 62 can be tilted. Piezoelectric or other actuators can be employed to move the lens 62. Movement of lens 62 can be used to supplement or substitute some of the relative movement between the workpiece 22 and the beam axis 22 to facilitate control of the incident machining angle ω and the azimuth Φ.

A laser system controller 190 preferably synchronizes the firing of the laser 184 to the motion of the stages 150 and 90 and fast positioner 90. The laser system controller 190 is shown generically to control the fast positioner 90, the stages 150 and 90, the laser 184, and a high-speed positioner controller 192. Skilled persons will appreciate that the laser system controller 190 may include integrated or independent control subsystems to control and/or provide power to any or all of these laser components and that such subsystems may be remotely located with respect to laser system controller 190. Laser system controller 190 also preferably controls the relative movement, including direction, tilt angles or rotation, and speed or frequency, of the high-speed positioner 160, either directly or indirectly through the high-speed positioner controller 192, as well as controls any synchronization with the laser 184 or components of positioning system 94. For convenience, the combination of the high-speed positioner 160 and the high-speed positioner controller 192 may be referred to as the secondary or nonintegrated positioning system.

Additional or alternative methods of beam positioning can be employed. Some additional or alternative methods of beam positioning are described in U.S. Pat. No. 5,751,585 of Donald R. Cutler et al., U.S. Pat. Nos. 6,706,999 of Spencer Barrett et al. and 7,019,891 of Jay Johnson, all of which are assigned to the assignee of this application, and all of which are incorporated herein by reference. It will also be appreciated that a multi-tool positioning system could be employed to direct two beams simultaneously to form the kerf, wherein each beam is directed to form a different side wall 124 of desired taper.

Exemplary laser pulse parameters include laser type, wavelength, pulse duration, pulse repletion rate, number of pulses, pulse energy, pulse temporal shape, pulse spatial shape, and focal spot size and shape. Additional laser pulse parameters include specifying the location of the focal spot relative to the surface of the workpiece 22 and directing the relative motion of the laser pulses with respect to the workpiece 22.

In some embodiments, laser parameters that may be advantageously employed for some embodiments include using lasers 184 with wavelengths that range from IR through UV, or more particularly from about 10.6 microns down to about 266 nm. The laser 184 may operate at 2 W, being in the range of 1 W to 100 W, or more preferably 1 W to 12 W. Pulse durations range from 1 picosecond to 1000 ns, or more preferably from about 1 picosecond to 200 ns. The laser repetition rate may be in a range from 1 KHz to 100 MHz, or more preferably from 10 KHz to 1 MHz. Laser fluence may range from about 0.1×10⁻⁶J/cm²to 100.0 J/cm² or more particularly from 1.0×10⁻² J/cm² to 10.0 J/cm². The speed with which the beam axis 32 moves with respect to the workpiece 22 ranges from 1 mm/s to 10 m/s, or more preferably from 100 mm/s to 1 m/s. The major spatial axis 18 of the laser spot 102 measured at the surface of the workpiece 22 may range from 10 microns to 1000 microns or from 50 microns to 500 microns.

Some exemplary laser processing systems operable for making kerfs 120 on or within the workpiece 22 are the ESI 5320, ESI MM5330 micromachining system, the ESI ML5900 micromachining system and the ESI 5955 micromachining system, all manufactured by Electro Scientific Industries, Inc., Portland, Oreg. 97229.

These laser-machining systems can employ almost any type of laser 184. Some embodiments employ a solid-state diode-pumped laser 184, which can be configured to emit wavelengths from about 366 nm (UV) to about 1320 nm (IR) at pulse repetition rates up to 5 MHz. However, these systems may be adapted by the substitution or addition of appropriate laser, laser optics, parts handling equipment, and control software to reliably and repeatably produce the selected laser spots 102 on the workpiece 22 as previously described. These modifications permit the laser processing system to direct laser pulses with the appropriate laser parameters to the desired locations on an appropriately positioned and held workpiece 22 at the desired rate and bite size between laser spots 102.

In some embodiments, the laser-machining system employs a diode-pumped Nd:YVO₄ solid-state laser 184 operating at 1064 nm wavelength, such as a model Rapid manufactured by Lumera Laser GmbH, Kaiserslautern, Germany. This laser can be optionally frequency doubled using a solid-state harmonic frequency generator to reduce the wavelength to 532 nm thereby creating visible (green) laser pulses, or tripled to about 355 nm or quadrupled to 266 nm thereby creating ultraviolet (UV) laser pulses. This laser 184 is rated to produce 6 Watts of continuous power and has a maximum pulse repetition rate of 1000 KHz. This laser 184 produces laser pulses with duration of 1 picosecond to 1,000 nanoseconds in cooperation with controller 54.

These laser pulses may be Gaussian or specially shaped or tailored by the laser optics, typically comprising one or more optical components positioned along an optical path 80, to permit desired characteristics of the laser spots 102. Specially shaped spatial profiles may be created using diffractive optical elements or other beam-shaping components. A detailed description of modifying the spatial irradiance profile of laser spots 102 can be found in U.S. Pat. No. 6,433,301 of Corey Dunsky et al., which is assigned to the assignee of this application, and which is incorporated herein by reference.

The foregoing is illustrative of embodiments of the invention and is not to be construed as limiting thereof. Although a few specific example embodiments have been described, those skilled in the art will readily appreciate that many modifications to the disclosed exemplary embodiments, as well as other embodiments, are possible without materially departing from the novel teachings and advantages of the invention.

Accordingly, all such modifications are intended to be included within the scope of the invention as defined in the claims. For example, skilled persons will appreciate that the subject matter of any sentence or paragraph can be combined with subject matter of some or all of the other sentences or paragraphs, except where such combinations are mutually exclusive.

It will be obvious to those having skill in the art that many changes may be made to the details of the above-described embodiments without departing from the underlying principles of the invention. The scope of the present invention should, therefore, be determined by the following claims, with equivalents of the claims to be included therein.

1. A method for laser-machining a feature in a workpiece, comprising:
providing a workpiece;
generating a beam of laser pulses along a beam axis propagating through a non-telecentric lens having a utilizable field of view over the workpiece, wherein the field of view has a perimeter;
causing relative motion between the beam axis and the workpiece in a cutting direction along a cutting path;
directing the beam axis through the non-telecentric lens onto the workpiece in proximity to the perimeter of the field of view to irradiate a first region on the workpiece along a cutting path with the beam, wherein the beam axis is incident upon the workpiece at a first nonzero machining angle and impinges upon the workpiece along a first nonzero azimuthal direction relative to a depthwise axis bisecting the workpiece; and
removing material of the workpiece within the first region along the cutting path to form a kerf including a first side wall having a first taper characteristic influenced by the first angle of incidence and the first azimuthal direction.

2. The method of claim 1, further comprising:
continuing to direct the beam axis through the non-telecentric lens onto the workpiece in proximity to the perimeter of the field of view to maintain the first taper characteristic of the first side wall while extending the kerf along the cutting path.

3. The method of claim 2, wherein the cutting path has curvature, the method further comprising:
changing the first azimuthal direction of the beam axis relative to the relative to the depthwise axis bisecting the workpiece to adjust for the curvature of the cutting path.

4. The method of claim 1, wherein the cutting path has curvature, and wherein the first region forms a first segment along the cutting path in a first direction, the method further comprising:
changing the first azimuthal direction of the beam axis relative to the relative to the depthwise axis bisecting the workpiece to cause the beam axis to be directed through the non-telecentric lens onto the workpiece in proximity to the perimeter of the field of view to irradiate a second region on the workpiece along the cutting path with the beam, wherein the beam axis is incident upon the workpiece at a second nonzero machining angle and impinges upon the workpiece along a second nonzero azimuthal direction relative to the relative to the depthwise axis bisecting the workpiece, wherein the second nonzero azimuthal direction is different from the first nonzero azimuthal direction, and wherein the second region forms a second segment along the cutting path in a second direction that departs from the first direction; and
removing material of the workpiece within the second region along the cutting path to extend the kerf in the second direction while maintaining the first taper characteristic of the first side wall as influenced by the second angle of incidence and the second azimuthal direction.

5. The method of claim 4, wherein the first machining angle and the second machining angle are the same.

6. The method of claim 4, wherein the first machining angle and the second machining angle are different.

7. The method of claim 4, wherein the first azimuthal direction and the second azimuthal direction have angular values that are different with respect to the cutting direction.

8. The method of claim 4, wherein the first azimuthal direction and the second azimuthal direction have angular values that are the same with respect to the cutting direction.

9. The method of claim 1, wherein the first machining angle of the beam axis is oriented at a nonzero beam-axis angle with respect to a lens axis of the non-telecentric lens.

10. The method of claim 1, wherein the first machining angle of the beam axis is oriented at a nonzero and non-perpendicular beam-axis angle with respect to an axial plane of the non-telecentric lens.

11. The method of claim 1, wherein the beam axis is directed to impinge the workpiece within 5 mm of the perimeter of the utilizable field of view.

12. The method of claim 1, wherein the beam axis is directed to impinge the workpiece within 2 mm of the perimeter of the utilizable field of view.

13. The method of claim 1, wherein the beam axis is directed to impinge the workpiece within 500 microns of the perimeter of the utilizable field of view.

14. The method of claim 1, wherein the beam axis is directed to impinge the workpiece within 100 microns of the perimeter of the utilizable field of view.

15. The method of claim 1, wherein the first machining angle of the beam axis is greater than 1 degree.

16. The method of claim 1, wherein the first azimuthal direction has an angular value that is greater than or equal to 45 degrees and less than 135 degrees with respect to the cutting direction.

17. The method of claim 1, wherein the first azimuthal direction has an angular value that is about 90 degrees with respect to the cutting direction.

18. The method of claim 1, wherein the beam axis is directed in a beam path on the workpiece in a repetitive pattern smaller than a width of the kerf and such that some laser spots along the beam path are first laser spots that form the first side wall and such that some laser spots along the beam path are second laser spots that form a second side wall, wherein the first laser spots are directed in the first azimuthal direction with respect to the cutting direction and wherein the second laser spots are directed in a second azimuthal direction with respect to the cutting direction.

19. A laser micromachining system for laser-machining a feature in a workpiece, comprising:
a laser operable for generating a beam of laser pulses of selected pulse parameters along a beam axis;
a non-telecentric lens operable for propagating therethrough and having a utilizable field of view over the workpiece, wherein the field of view has a perimeter;
a workpiece stage operable for supporting and moving the workpiece;
a fast positioner operable for directing the beam axis through the non-telecentric lens and directly or indirectly toward target positions on the workpiece;
a positioner stage for supporting and moving a fast positioner relative to the workpiece; and
a controller operable to control motion of the workpiece stage and the fast positioner stage and operable to control the fast positioner to direct the laser pulses along the beam axis and maintain the beam axis at one or more selected machining angles and one or more selected azimuths through the non-telecentric lens onto the workpiece in proximity to the perimeter of the field of view to the target positions to form a kerf having a side wall with selected taper characteristics determined by the selected pulse parameters, the one or more selected machining angles, and the one or more selected azimuths.

20. A method for laser-machining a feature in a workpiece, comprising:
providing a workpiece having a surface;
providing a workpiece stage operable for supporting the workpiece and moving the workpiece;
generating a beam of laser pulses having selected laser parameters and propagating the laser pulses along a beam axis;
providing a fast positioner operable for directing the beam axis through the non-telecentric lens and directly or indirectly toward target positions on the workpiece, wherein the non-telecentric lens has a central lens axis that is generaly perpendicular to the surface of the workpiece;
causing relative motion between the beam axis and the workpiece in a cutting direction along a cutting path; and
directing the beam axis through the non-telecentric lens onto the workpiece to irradiate a first region on the workpiece along a cutting path with the beam to remove material of the workpiece within the first region along the cutting path to form a kerf including a first side wall, a bottom, and a second side wall, wherein the central lens axis is positioned at a greater distance from the first side wall than from the second side wall, the wherein the beam axis is incident upon the workpiece at a selected nonzero machining angle and impinges upon the workpiece along a selected nonzero azimuthal direction relative to the cutting direction such that the first side wall is formed with a taper characteristic determined by the selected pulse parameters, the selected machining angle, and the selected azimuthal direction.
